(19) United States
(12) Patent Application Publication
(10) Pub. No.: US 2016/0334663 A1
(43) Pub. Date: Nov. 17, 2016

(54) LIQUID CRYSTAL DISPLAY PANEL

(71) Applicant: BOE TECHNOLOGY GROUP CO., LTD., Beijing (CN)

(72) Inventors: Jaegeon YOU, Beijing (CN); Qian JIA, Beijing (CN)

(21) Appl. No.: 14/905,387

(22) PCT Filed: Jun. 11, 2015
(86) PCT No.: PCT/CN2015/081211

§ 371 Date: Jan. 15, 2016

(30) Foreign Application Priority Data
Jan. 22, 2015 (CN) 201510033138.6

(51) Int. Cl. G02F 1/1339; G02F 1/1335

(52) U.S. Cl. CPC G02F 1/13394; G02F 1/133528; G02F 2001/133302

(57) ABSTRACT

The present invention provides a liquid crystal display panel, belongs to the field of liquid crystal display technology, and solves a problem of serious light leak in dark state in an existing liquid crystal display panel. The liquid crystal display panel of the present invention comprises a first substrate and a second substrate assembled in an aligned manner, and liquid crystals provided between the first and second substrates, both the first and second substrates comprise a base which comprises glass, and the maximum stress in the glass of the base is smaller than or equal to 0.4 MPa.

### CROSS-REFERENCES TO RELATED APPLICATIONS

This application claims priority benefit from Chinese Application No. 201510033138.6, filed to State Intellectual Property Office of the People's Republic of China on Jan. 22, 2015, the content of which is hereby incorporated by reference by its entirety.

### FIELD OF THE INVENTION

The present invention belongs to the field of liquid crystal display technology, and particularly relates to a liquid crystal display panel.

### BACKGROUND OF THE INVENTION

A liquid crystal display panel comprises a first substrate and a second substrate (e.g., an array substrate and a color filter substrate) assembled in an aligned manner, liquid crystals are provided between the two substrates, and polarizers are provided at outer sides of the two substrates. Light from a backlight source becomes linearly polarized light after passing through a polarizer, and then changes its polarization direction in the liquid crystal layer so that filtering of different extents occurs when the light goes through and exits from another polarizer, thus realizing display.

However, it is found from practice that, in dark state (i.e., with a plain black screen displayed), light leak in the liquid crystal display panel is severe, and especially in an advanced super dimension switch mode (ADS mode) liquid crystal display panel, light leak is more obvious. However, there is no good solution to such a problem in the prior art.

### SUMMARY OF THE INVENTION

In view of the problem of serious light leak under dark state in an existing liquid crystal display panel, the present invention provides a liquid crystal display panel, which hardly leaks light under dark state.

In order to achieve the above object, the present invention provides a liquid crystal display panel comprising a first substrate and a second substrate assembled in an aligned manner, and liquid crystals provided between the first and second substrates, both the first and second substrates comprise a base which comprises glass, and,

the maximum stress in the glass of the base is smaller than or equal to 0.4 MPa.

Preferably, the base is made of glass.

Further preferably, a thickness of the base is smaller than or equal to 0.5 mm.

Further preferably, a thickness of the base is in the range of 0.1 mm to 0.5 mm.

Preferably, the liquid crystal display panel further comprises: polarizers provided on sides of the first substrate and the second substrate away from the liquid crystals, respectively, and Young's moduli of the polarizers are smaller than or equal to 2500 MPa.

Further preferably, the polarizers are polymethyl methacrylate polarizers.

Preferably, in dark state, liquid crystal retardation value of the liquid crystals is in the range of 373 nm to 405 nm.

Preferably, the liquid crystal display panel further comprises: spacers provided between the first substrate and the second substrate, each spacer comprises a first spacer, whose bottom is connected to the first substrate, and a second spacer, whose bottom is connected to the second substrate, the first spacers are in one-to-one correspondence with the second spacers, and concave and convex structures matching with each other are provided at the top of the first spacer and the top of the second spacer corresponding to the first spacer, respectively.

Preferably, the base comprises resin and glass fiber distributed in the resin, and a ratio of an elastic coefficient of the glass fiber to an elastic coefficient of the resin is larger than or equal to 25.

Preferably, the liquid crystal display panel is an advanced super dimension switch mode liquid crystal display panel.

In the liquid crystal display panel of the present invention, the stress in the glass of the base is restrained, and the inventors found that the stress in the glass is the main cause of light leak in dark state, so by adopting the base with small stress therein, the light leak in dark state is reduced, and the problem of serious light leak in dark state is solved.

### BRIEF DESCRIPTION OF THE DRAWINGS

FIG. 1 is a schematic diagram of a cross-sectional structure of a liquid crystal display panel according to an embodiment of the present invention.

FIG. 2 is a diagram illustrating correspondence between retardation and light leak of a liquid crystal display panel according to an embodiment of the present invention.

### REFERENCE NUMERALS

1, first substrate; 2, second substrate; 3, liquid crystal; 4, polarizer; 51, first spacer; 52, second spacer.

### DETAILED DESCRIPTION OF THE EMBODIMENTS

To enable those skilled in the art to better understand the technical solutions of the present invention, the present invention will be further described in detail below in conjunction with the accompanying drawings and the specific implementations.

### EMBODIMENT

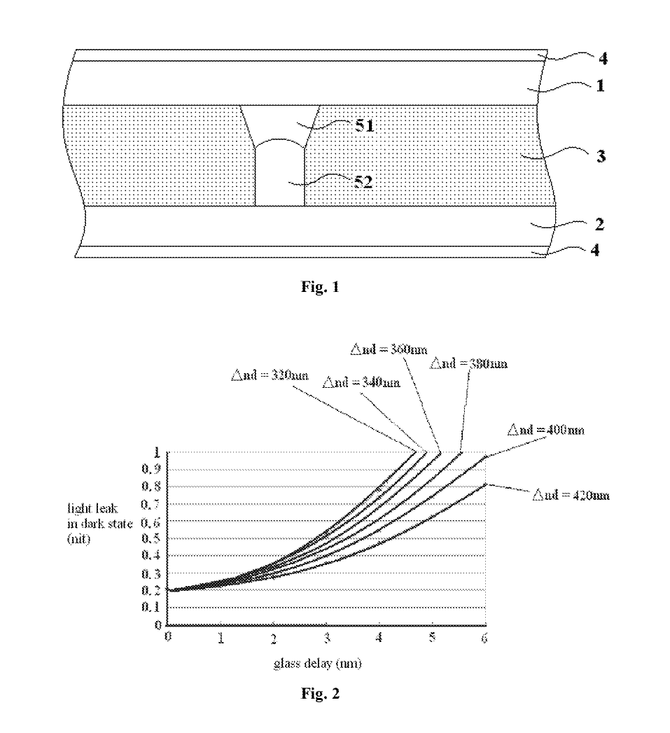

As shown in FIG. 1, the present embodiment provides a liquid crystal display panel comprising a first substrate 1 and a second substrate 2, which are assembled in an aligned manner, and liquid crystals 3 provided between the first substrate 1 and the second substrate 2. Both the first substrate 1 and the second substrate 2 comprise a base, which includes glass.

Namely, the liquid crystal display panel comprises the first substrate 1 and the second substrate 2 assembled in an aligned manner (e.g., the first substrate 1 is formed to be an array substrate, and the second substrate 2 is formed to be a color filter substrate), and the liquid crystals 3 are provided between the first substrate 1 and the second substrate 2. Each of the first substrate 1 and the second substrate 2 comprises a base functioning as a support. Various structures for display (such as gate lines, data limes, thin film transistors, pixel electrodes, common electrodes, color filers, and the like) are provided on the base, and at least part of the base is made of glass.

Here, the liquid crystal display panel is preferably an advanced super dimension switch mode (ADS mode) liquid crystal display panel.

This is because in the prior art, light leak in the advanced super dimension switch mode liquid crystal display panel under dark state is relatively severe. In the present embodiment, description is given by taking the ADS mode liquid crystal display panel as an example. It should be understood, however, the present invention is also applicable to a liquid crystal display panel of other mode.

In the liquid crystal display panel of the present embodiment, the maximum stress in the glass of the base is smaller than or equal to 0.4 MPa (MegaPascal).

In a general case, glass is transparent, and will not influence the state of transmitted light. But the inventors found that glass becomes a birefringent material when stress exists in the glass, which results in a delay (hereinafter referred to as base delay) in the transmitted light, and the base delay causes undesirable light leak. When regular content with certain brightness is displayed, the light leak accounts for small proportion, and has little influence on display, but under dark state (i.e., with plain black screen displayed), the light leak becomes obvious, and thus becomes a critical influence on display. Therefore, reducing the stress in glass can reduce deformation thereof, and thus achieves an effect of lowering light leak in dark state. In a conventional liquid crystal display panel, the stress in the base (glass) is generally above 1 MPa. The study found that light leak can be significantly reduced when the stress is smaller than or equal to 0.4 MPa.

Preferably, according to an implementation of the present embodiment, the base is made entirely of glass, and the following description is given by taking this case as an example.

Preferably, a thickness of the base is smaller than or equal to 0.5 mm, and more preferably, in the range of 0.1 mm to 0.5 mm.

By reducing thickness of the base, the stress therein can be reduced, and since the base delay is related to the thickness, in the case of the same stress, the smaller thickness, the smaller delay. Therefore, a base with a relatively small thickness is preferably adopted. However, the thickness of the base cannot be too small to provide sufficient strength, and therefore the thickness of the base is preferably in the range of 0.1 mm to 0.5 mm.

Preferably, the liquid crystal display panel further comprises spacers provided between the first substrate 1 and the second substrate 2, each spacer comprises a first spacer 51, whose bottom is connected to the first substrate 1, and a second spacer 52, whose bottom is connected to the second substrate 2, the first spacers 51 are in one-to-one correspondence with the second spacers 52, and concave and convex structures matching with each other are provided at the top of the first spacer 51 and the top of the second spacer 52 corresponding to the first spacer 51, respectively.

Namely, as shown in FIG. 1, in the liquid crystal display panel in the present embodiment, the spacer is made up of two parts which are respectively provided on the two substrates and whose ends are butted against each other through the concave and convex structures that match with each other.

In the prior art, in order to keep a distance (cell thickness) between the two substrates, it is necessary to provide a plurality of spacers between the two substrates, and the spacers are generally arranged on one substrate with the tops of the spacers contacting the other substrate. In this way, when slight deformation occurs in the liquid crystal display panel, there is a tendency of relative motion between the spacers and the substrate contacting the spacers. That is, the spacers may exert a frictional force on the substrate, which results in increased stress in the base and thus causes light leak. In the liquid crystal display panel according to the present embodiment, the spacer thereof is divided into two parts, so the frictional force is mainly concentrated in a position where the two spacers contact with each other, thereby reducing the frictional force and the stress applied to the base.

Preferably, the liquid crystal display panel further comprises polarizers 4 provided on sides of the first substrate 1 and the second substrate 2 away from the liquid crystals 3, respectively, and Young's moduli of the polarizers 4 are smaller than or equal to 2500 MPa; more preferably, the polarizers 4 are polymethyl methacrylate polarizers.

The study found that, by adopting relatively soft polarizers 4, the base delay can also be reduced. Most of the existing polarizers 4 are cellulose triacetate (TAC) polarizers, whose Young's moduli are generally about 3200 MPa and which have a large hardness. If, however, polarizers with the Young's moduli smaller than or equal to 2500 MPa are adopted, light leak can be significantly reduced. The above-mentioned relatively soft polarizers 4 may be polymethyl methacrylate (PMMA) polarizers, whose Young's moduli are generally about 2100 MPa. In addition, the polymethyl methacrylate polarizers further have better waterproofness and lower photoelasticity, and are conducive to reducing light leak.

Preferably, in dark state, liquid crystal retardation value of the liquid crystals 3 between the two substrates is in the range of 373 nm to 405 nm. A value calculated by using the formula Δn×d is the liquid crystal retardation value of the liquid crystals 3, where Δn is a difference between the refractive indices of the liquid crystals 3 for ordinary light and extraordinary light, and d is the thickness of the liquid crystals 3.

The liquid crystals 3 are also a birefringent material, and will thus cause a delay of light, and the delay amount is equal to Δn×d, where Δn is a difference (a value in the case of dark state of the liquid crystal display panel) between the refractive indices of the liquid crystals 3 for ordinary light (o light) and extraordinary light (e light), and d is the thickness of the liquid crystals 3. The study found that proper increase in the light delay (liquid crystal retardation) caused by the liquid crystals 3 can reduce light leak in the liquid crystal display panel.

TABLE 1
performance comparison among liquid crystal display panels

| | | | Comparative |
|---|---|---|---|
| Item | Embodiment 1 | Embodiment 2 | Example |
| base thickness | 0.5 | 0.5 | 0.7 |
| (mm) | | | |
| Δn of liquid | 0.121 | 0.111 | 0.097 |
| crystals | | | |
| type of | polymethyl | polymethyl | cellulose |
| polarizer | methacrylate | methacrylate | triacetate |
| | polarizer | polarizer | polarizer |
| level of light leak | 1.19 | 1.68 | 2.43 |

ADS mode liquid crystal display panels with different base thicknesses, liquid crystal retardations and polarizers 4 are prepared and the levels of light leak thereof under dark state are tested. Here, the liquid crystals in different display panels have the same thickness d, and thus the value of Δn thereof can represent the delay amount Δn×d, while the levels of light leak range from level 0 to level 5, where level 0 indicates no light leak, and level S indicates very serious light leak.

Table 1 shows levels of light leak of the liquid crystal display panels with different base thicknesses, Δn of liquid crystals and polarizers. It can be seen from table 1 that, compared to the comparative example, in Embodiments 1 and 2, the base thicknesses are smaller, the liquid crystal retardations (represented by Δn) are larger, the polarizers 4 are softer, but the levels of light leak are lower. This proves that the above changes can reduce light leak. In the meanwhile, compared to Embodiment 2, in Embodiment 1, the liquid crystal retardation is larger, and the level of light leak is smaller, which indicates that increasing liquid crystal retardation can reduce light leak.

When other conditions remain unchanged, the liquid crystal display panels with different liquid crystal retardations and base delays are prepared, the light leak thereof is tested and the result is shown in FIG. 2. It can be seen that, in the case of constant liquid crystal retardation, the larger base delay, the more light leak: in the case of constant base delay, the larger liquid crystal retardation, the less light leak. This indicates that decreasing base delay and increasing liquid crystal retardation are conducive to reducing light leak.

Preferably, as another implementation of the present embodiment, the base may not be entirely made of glass, but merely include glass material. Preferably, the base comprises resin and glass fiber distributed in the resin, and a ratio of an elastic coefficient of the glass fiber to an elastic coefficient of the resin is larger than or equal to 25.

Namely, transparent resin (such as polyester resin, polyethylene resin) may be used as main material of the base, and meanwhile, glass fiber is added therein as enhancement. Apparently, the stress in the glass fiber will result in light leak as well. Glass content in the base made of such composite material is small, so the resultant delay is relatively small; in addition, when a ratio of an elastic coefficient of the glass fiber to an elastic coefficient of the resin is larger than or equal to 25 (i.e., the glass is much harder than the resin), the stress in the base is mainly concentrated in the resin (the resin subjected to the stress will not cause light leak), thereby decreasing the stress in the glass and reducing light leak.

It can be understood that, the above implementations are merely exemplary implementations used for explaining the principle of the present invention, but the present invention is not limited thereto. For those skilled in the art, various modifications and improvements may be made without departing from the spirit and essence of the present invention, and these modifications and improvements are also deemed as falling within the protection scope of the present invention.

1. A liquid crystal display panel, characterized in that, the liquid crystal display panel comprises a first substrate and a second substrate assembled in an aligned manner, and liquid crystals provided between the first and second substrates, both the first and second substrates comprise a base which comprises glass, wherein,
the maximum stress in the glass of the base is smaller than or equal to 0.4 MPa.

2. The liquid crystal display panel according to claim 1, characterized in that, the base is made of glass.

3. The liquid crystal display panel according to claim 2, characterized in that, a thickness of the base is smaller than or equal to 0.5 mm.

4. The liquid crystal display panel according to claim 3, characterized in that, a thickness of the base is in the range of 0.1 mm to 0.5 mm.

5. The liquid crystal display panel according to claim 1, characterized in that, the liquid crystal display panel further comprises:
polarizers provided on sides of the first substrate and the second substrate away from the liquid crystals, respectively, and Young's moduli of the polarizers are smaller than or equal to 2500 MPa.

6. The liquid crystal display panel according to claim 5, characterized in that, the polarizers are polymethyl methacrylate polarizers.

7. The liquid crystal display panel according to claim 1, characterized in that, in dark state, liquid crystal retardation value of the liquid crystals is in the range of 373 nm to 405 nm.

8. The liquid crystal display panel according to claim 1, characterized in that, the liquid crystal display panel further comprises:
spacers provided between the first substrate and the second substrate, each spacer comprises a first spacer, whose bottom is connected to the first substrate, and a second spacer, whose bottom is connected to the second substrate, the first spacers are in one-to-one correspondence with the second spacers, and concave and convex structures matching with each other are provided at the top of the first spacer and the top of the second spacer corresponding to the first spacer, respectively.

9. The liquid crystal display panel according to claim 1, characterized in that, the base comprises resin and glass fiber distributed in the resin, and a ratio of an elastic coefficient of the glass fiber to an elastic coefficient of the resin is larger than or equal to 25.

10. The liquid crystal display panel according to claim 1, characterized in that,
the liquid crystal display panel is an advanced super dimension switch mode liquid crystal display panel.
